(19) United States
(12) Patent Application Publication
(10) Pub. No.: US 2024/0362716 A1
(43) Pub. Date: Oct. 31, 2024

(54) SYSTEM AND METHOD FOR ALTERNATIVE INVESTMENT ASSET DASHBOARD

(71) Applicant: Wells Fargo Bank, N.A., San Francisco, CA (US)

(72) Inventor: Adam Mark Woiwood, Clive, IA (US)

(21) Appl. No.: 18/307,643

(22) Filed: Apr. 26, 2023

(51) Int. Cl. G06Q 40/06

(52) U.S. Cl. CPC G06Q 40/06

(57) ABSTRACT

Various examples are directed to computer-implemented systems and methods for providing an alternative investment asset dashboard. A method includes receiving a financial asset input indicating financial instruments from or regarding a user having an online financial services account, and using the financial asset input to locate and extract physical asset data or impact data based on the financial asset input. Physical assets or impacts of financial instruments are determined based on the physical asset data or the impact data, and an investment asset dashboard is composed for the user based on the physical assets or the impacts. The investment asset dashboard is displayed on a graphical user interface.

### TECHNICAL FIELD

This document relates generally to computer systems and more particularly to systems and methods for an alternative investment asset dashboard.

### BACKGROUND

Financial consumers have begun to value additional non-monetary considerations when selecting financial instruments for their respective portfolios. Some of these considerations include sustainability ratings, equity initiatives, and types of labor employed by the companies that are represented in the financial instruments. Additional considerations may include physical assets of the financial instruments and the like. Financial consumers may benefit from knowledge of these considerations with respect to financial instruments in their portfolio, and with respect to financial instruments that they are considering adding to their portfolio. Improved systems and methods for an alternative investment asset dashboard are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a method for an alternative investment asset dashboard, according to various embodiments;

FIG. 1B illustrates an example embodiment of a method for providing an alternative investment asset dashboard, according to various embodiments;

FIG. 1C illustrates an example embodiment of an alternative investment asset dashboard, according to various embodiments;

FIG. 2 illustrates an exemplary infrastructure for use in the present subject matter, according to various embodiments;

FIG. 3 illustrates an example machine learning module for an alternative investment asset dashboard, according to various embodiments;

FIG. 4 illustrates a flowchart of a method of training a model for an alternative investment asset dashboard, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

Individuals may value additional non-monetary considerations when selecting financial instruments for their respective portfolios. Some of these considerations include sustainability ratings, equity initiatives, and types of labor employed by the companies that are represented in the financial instruments. Additional considerations may include physical assets of the financial instruments and the like. Improved systems and methods for an alternative investment asset dashboard are needed.

The present subject matter provides systems and methods for an alternative investment asset dashboard. A method includes receiving a financial asset input indicating financial instruments from or regarding a user having an online financial services account, and using the financial asset input to locate and extract physical asset data or impact data based on the financial asset input. Physical assets or impacts of financial instruments are determined based on the physical asset data or the impact data, for example by using machine learning, and an investment asset dashboard is composed for the user based on the physical assets or the impacts. The investment asset dashboard is displayed on a graphical user interface. In some examples, the online financial services account of the user is monitored, and upon detecting user access, the investment asset dashboard is displayed on the graphical user interface.

The present system for providing an alternative investment asset dashboard may include a specialized computer system for providing users with an interface to access data within the systems, providing the users with an interface to monitor the system, and may further include customized or dedicated computer storage or memory for the users, in various embodiments.

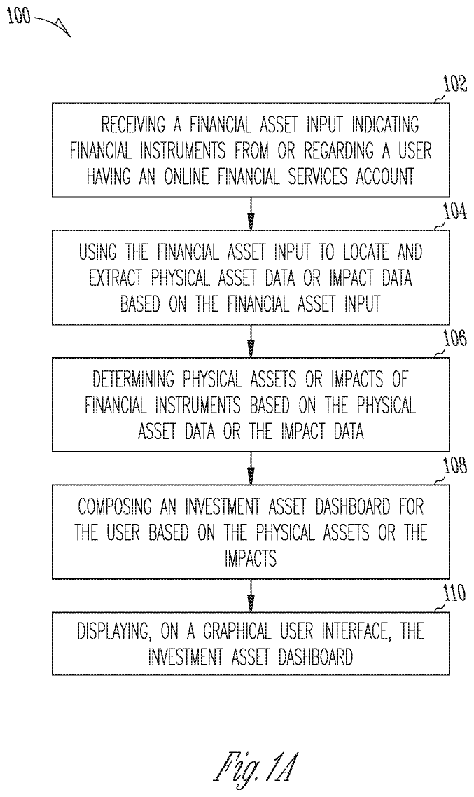

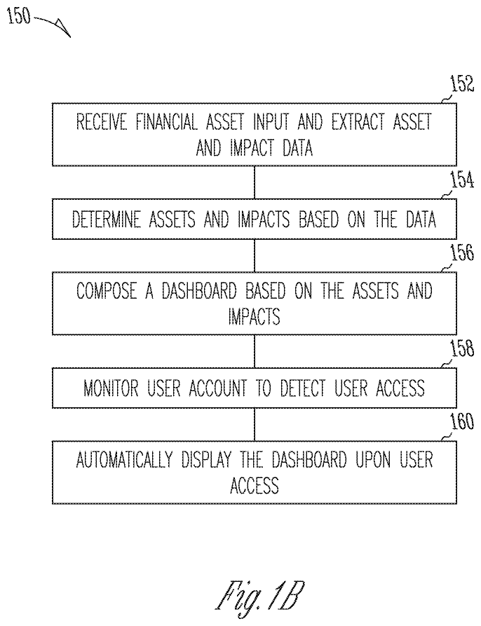

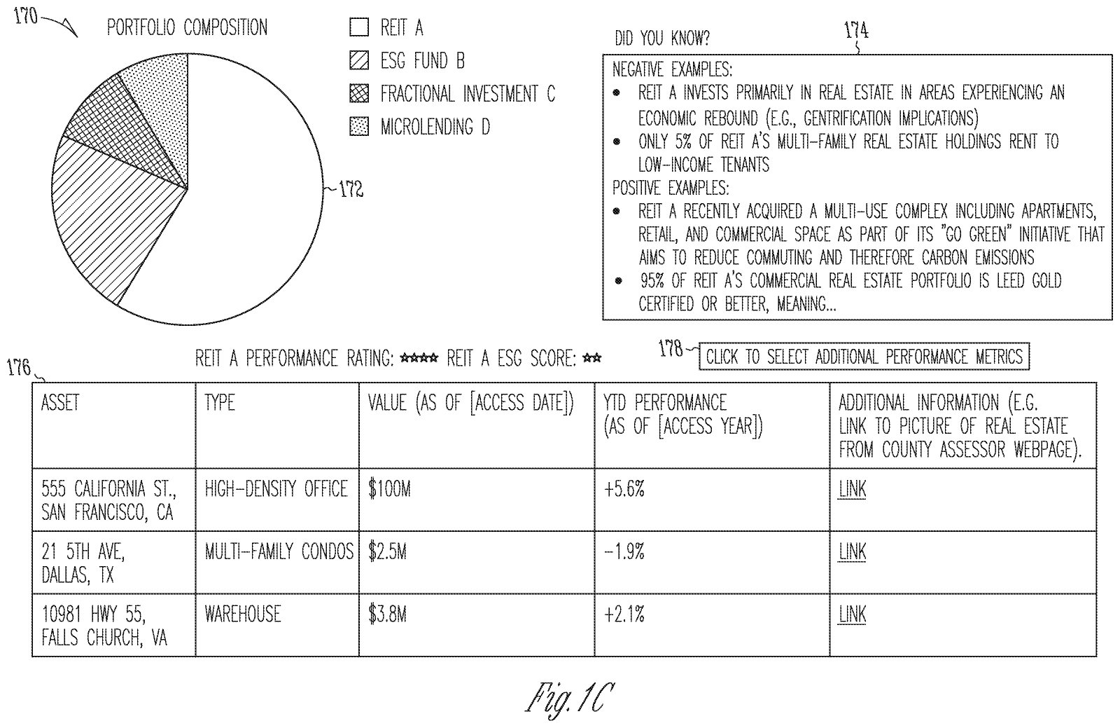

FIG. 1A illustrates an example embodiment of a method for an alternative investment asset dashboard, according to various embodiments. The method 100 includes receiving a financial asset input indicating financial instruments from or regarding a user having an online financial services account, at step 102. In some embodiments, the financial asset input may be obtained by searching a database or the internet. The financial asset input may be received from one or more user inputs, in various examples. In one example, the financial asset input may be a list of stocks and bonds in a user portfolio. In another example, the financial asset input may be a list of stocks and bonds a user wants to purchase or otherwise monitor or track. Other types of financial asset inputs may be used without departing from the scope of the present subject matter.

At step 104, the method 100 includes using the financial asset input to locate and extract physical asset data or impact data based on the financial asset input. In various examples, the asset data or impact data may be obtained by searching a database or the internet. The asset or impact data my be extracted from one or more user inputs, in various embodiments. The asset or impact data may be extracted using machine learning, in various embodiments.

The method 100 further includes determining physical assets or impacts of financial instruments based on the physical asset data or the impact data, at step 106. The assets or impacts may be determined using machine learning, such as by using a machine learning model including one or more of a long short-term memory (LSTM) network, bidirectional encoder representations from transformers (BERT), natural language processing (NLP), or an artificial intelligence (AI)-based knowledge tree, in various embodiments.

The method 100 also include composing an investment asset dashboard for the user based on the physical assets or the impacts, at step 108. In various embodiments, composing the investment asset dashboard includes composing one or more graphic displays representing the determined physical assets. Composing the investment asset dashboard includes composing one or more text segments identifying assets and/or impacts, in various examples. The dashboard may be composed using machine learning, such as by using a machine learning model including one or more of a long short-term memory (LSTM) network, bidirectional encoder representations from transformers (BERT), natural language processing (NLP), or an artificial intelligence (AI)-based knowledge tree, in various embodiments. At step 110, the method 100 includes displaying, on a graphical user interface, the investment asset dashboard. In various examples, displaying the investment asset dashboard includes suggesting alternative investment options to offset assets or impacts. For example, if the dashboard indicates a user owns a company that has a negative environmental impact, the dashboard may provide the user with options for investment in companies that have a positive environmental impact. In various embodiments, displaying the investment asset dashboard includes displaying one or more text, graphic, or photographic displays representing the determined physical assets. Displaying the investment asset dashboard includes displaying a family view to provide assets and impacts of financial instruments owned by family members of the user, in various examples.

In various embodiments, the method may further include monitoring the online financial services account of the user to detect user access. The financial services account may be monitored for a user entering an identification and password from a user device, or for the user opening an application or website, in various embodiments. The method may further include, upon detecting user access to the online financial services account, displaying, on the graphical user interface, the investment asset dashboard, in various embodiments.

In various embodiments, the method 100 further includes computing, using the machine learning for example, an index score based on the determined impacts. For example, an index score may be computed to provide a summary of the impacts of all holdings of the user, and compare it with other users. The index may be a number of a scale from a maximum to a minimum, for example. Displaying the investment asset dashboard includes displaying the index score, in one example. In various embodiments, the method 100 further includes providing, by the computer system, a notification to the user to alert the user to changes in the investment asset dashboard. In one embodiment, the notification includes a push notification. In another embodiment, the notification includes an email notification.

According to various embodiments, the present system provides a dashboard to illustrate physical assets of the stock a user owns. For example, the dashboard may indicate that “you own part of this company that owns this building in Manhattan” or “you own stock in a company that owns this restaurant in your neighborhood,” etc. In some embodiments, when a user opens up a financial services application or website, the system detects the access and provides a dashboard with a “did you know” view that illustrates some interesting asset of a company in which the user owns a share. The user may opt in to receiving the updates, such as push notifications or alerts on a periodic basis from the dashboard with “did you know”, good or bad qualitative messages regarding assets or impacts, or the like, in an example. The updates may be provided on a daily, weekly or other periodic basis selectable by the user, or upon log in to the account of the user, in various examples. In other examples, the updates may be provided automatically. In various embodiments, the dashboard may provide negative impacts of a fund or company in which a user has an ownership interest. For example, the dashboard may indicate that “did you know you own this company that funds child labor in country X?” In some examples, the dashboard may provide recommendations or suggestions for purchases or sales of financial instruments to offset a user's holdings in “evil” companies.

In further examples, if a user purchases a small segment of an asset that includes such components as a non-fungible token (NFT), art, wine, cars, property, etc., the dashboard may show “I own part of this art” or “I own part of this building,” and may display a photo of the art or the building. In this way, a user is informed of assets held by the financial instruments, such as index funds or the like, instead of only the amount of shares. In various embodiments, the dashboard my provide a user with definitions of acronyms, such as real estate investment trusts (REIT) or other financial instrument related acronyms. The present dashboard provides a more granular investing experience for a user, in various embodiments. The present dashboard thus illustrates impact of a user's investments instead of just a stock ticker.

In one example, the dashboard may illustrate a specific asset and/or impact each time the user opens or signs on to the financial services account, website or application. According to various embodiments, the dashboard my include a “shame scale” or index that informs a user of the negative impacts of the user's owned assets compared to other users. In one example, the dashboard may provide a family view to compare the impacts or index values with those of family members that use the same financial services application or website. The dashboard may be used by young investors to avoid duplicating investment with their parents or siblings, in one example. In other examples, the user or investor may be able to influence investing decisions of their relatives by using the impacts or index of the dashboard.

The present dashboard illustrates physical assets of the stock a user owns when they open the application or website, in various examples. A user may benefit by knowing not only facts about wealth creation, but also by knowing that they own part of a physical asset. For example, a user may own a portion of an exchange-traded fund (ETF), but not know which companies are part of the fund, or what the companies have accomplished or recently designed. In addition, if a user desires to improve environmental, social or governance (ESG) investing with respect to a specific user value set, the user may be prompted for what types of information the dashboard will provide. For example, the dashboard may show that a user's portfolio includes oil company shares, and the dashboard may further provide alternative or additional investment options to offset or replace those shares, such as providing information on an investment that includes a wind farm or other clean energy asset. In various embodiments, the user may be able to initiate trades to buy or sell assets from the dashboard. In other examples, the user may access other accounts or contact their financial advisor to refine their portfolio based on the dashboard, including using a link in the dashboard to obtain the access or make the contact to the advisor.

In various embodiments, the user may be able to select or click on items in the dashboard to drill down or obtain more information on a selected asset. The user may also be able to obtain a score or index (shame scale, for example) to indicate the overall impacts of their investment portfolio. This score or index (or badge) may be transferrable to social media, in an embodiment, so that a user can show their index to others to encourage or challenge them regarding investment impacts, in various embodiments. In some embodiments, the index may provide levels with labels (or digital stickers) such as “clean energy investor” that can be provided in the dashboard and shared with others at the discretion of the user.

The dashboard may be provided as a statement pushed to a user via email or other notification, in various embodiments. In some embodiments, the statement may be provided periodically, such as monthly or weekly, or may be available on demand or at a schedule provided by a user request from the financial services account interface. In one embodiment, the dashboard or statement may be provided based on an action by the owned company, such as a pharmaceutical company releasing a new medication. In various embodiments, the user may receive a pop up while on the financial service application or website, and a user may be able to click on the pop up to obtain more information or obtain the rest of the dashboard. The system may provide a push notification or email to the user based on an action, in an embodiment, and the user may be able to access the dashboard from a link in the notification or email.

In various embodiments, the dashboard is automatically provided to a user when access to their financial services account is detected. In other embodiments, the user may be prompted to opt in to having the dashboard provided. In still additional embodiments, the user may be able to select whether the dashboard is performance oriented or impact and asset oriented. In further embodiments, the user may be able to toggle dashboard entries on or off depending on category. The present system may access data at a granular level of the financial services provider of the user account, in some examples. In other examples, the dashboard system may access data from other financial services providers or data generally available in public databases or on the internet.

The present system may be provided generally to the public, or may be restricted to current investors or new potential customers of a financial institution, in various examples. According to various embodiments, a user-specific dashboard may be available to only customers of the financial services provider. In other embodiments, a sample dashboard may be shared with potential customers to encourage participation or improved ESG investing, for example. ESG investing is a way of investing in companies based on their commitment to one or more ESG factors, such as sustainable investing or socially responsible investing. The sample dashboard may show a hypothetical portfolio, or a potential user may be able to personalize the dashboard for their portfolio, and for their performance and qualitative considerations, in various examples. In various embodiments, the dashboard may be provided to include categories of alternative investment, or for any real asset outside of stock or equity. In some examples, the dashboard may be used to keep track of another user's investment impacts or assets (such as a relative) and their index or badge may be obtained.

In various examples, the user may obtain a different “did you know” fact upon every access to their financial services account, to become informed about the relationship between their stocks and funds and the impacts or physical assets owned by those stocks and funds. In one example, the dashboard may provide a notice highlighting positive aspects of the user portfolio. According to various embodiments, the user may be able to enter a hypothetical portfolio (or just individual hypothetical investments, funds or stocks) to see assets and impacts of stocks and funds that they may be interested in acquiring. In some embodiments, the present system may consider whether companies that are subjects of potential investing participate in self-reporting of factors that may be important to a user, such as diversity, equity and inclusion (DEI) lists, etc.

FIG. 1B illustrates an example embodiment of a method for providing an alternative investment asset dashboard, according to various embodiments. According to various embodiments, the method 150 may include receiving financial asset input and extracting impact data, at step 152. According to various embodiments, the financial asset input may be obtained by querying the user's account. In some embodiments, the financial asset input may be obtained by searching a database or the internet. The financial asset input may be obtained from one or more user inputs, in various examples. In various examples, the asset data or impact data may be obtained by searching a database or the internet using the financial asset input. The asset or impact data may be extracted from one or more user inputs, in various embodiments. The asset or impact data may be extracted using machine learning, in various embodiments.

The method 150 may also determining assets and impacts based on the data, at step 154. In some examples, machine learning is used to determine the assets and impacts. In other examples, the assets and impacts are determined without machine learning, such as by mining data from databases. Using machine learning includes using a machine learning model including one or more of a long short-term memory (LSTM) network, bidirectional encoder representations from transformers (BERT), natural language processing (NLP), or an artificial intelligence (AI)-based knowledge tree, in various embodiments.

The method 150 continues at step 156, where a dashboard is composed based on the assets and impacts, in various examples. In various embodiments, composing the investment asset dashboard includes composing one or more graphic displays representing the determined physical assets. Composing the investment asset dashboard includes composing one or more text segments identifying assets or impacts, in various examples. In some examples, machine learning is used to compose the investment asset dashboard. In other examples, the dashboard is composed without machine learning, such as by mining data from databases. The present system may include machine learning or AI that can write text for the dashboard, in various embodiments. For example, the system may use a large language model (LLM) such as Chat GPT to generate the text, in various embodiments.

At step 158, the method 150 may include monitoring a user account to detect user access, in various embodiments. The financial services account may be monitored for a user entering an identification and password from a user device or for the user accessing an application or website, in various embodiments. At step 160, the method may include automatically displaying the dashboard upon user access on a graphical user interface, in various embodiments. In various examples, displaying the investment asset dashboard includes suggesting alternative investment options to offset assets or impacts. Displaying the investment asset dashboard includes displaying a family view to provide assets and impacts of financial instruments owned by family members of the user, in various examples.

In various embodiments, the method 150 further includes computing an index score based on the determined impacts. The index score may be computed using machine learning, in an embodiment. The index score may be computed using a numerical calculation, in various embodiments. Displaying the investment asset dashboard includes displaying the index score, in one example. In various embodiments, the method 150 further includes providing, by the computer system, a notification to the user to alert the user to changes in the investment asset dashboard. In various embodiments, the notification may include a push or an email notification. Calculations and predictions used herein may include using a blockchain, smart contracts, or machine learning, in various embodiments.

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1A-1B. In some examples, the machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. Other types of machine learning models may be used without departing from the scope of the present subject matter. In some examples, the present platform may use a blockchain and/or smart contracts to implement the alternative investment asset dashboard.

Various embodiments include a non-transitory computer-readable storage medium, the non-transitory computer-readable storage medium including instructions that, when executed by computers, cause the computers to perform operations including the methods of FIGS. 1A-1B. In various embodiments, the present system runs simulations to train the machine learning models, and to identify process improvements and optimization for an alternative investment asset dashboard. Training of the models may be accomplished online or offline, in various embodiments. According to various embodiments, the method may include using artificial intelligence.

FIG. 1C illustrates an example embodiment of an alternative investment asset dashboard, according to various embodiments. In various embodiments, an alternative investment asset dashboard 170 for a user includes a portfolio composition graph 172 of the user's portfolio. In some embodiments, the user may select a portion of the graph 172 by clicking on the portion to obtain additional information about a financial instrument represented in the graph 172. In various examples, a performance rating table 176 may be provided on the display to show aspects, such as assets or impacts, of one or more financial instruments of the user portfolio, and may be displayed automatically or upon user selection. A “did you know” section 174 may be provided on the display to illustrate information about assets or impacts of one or more financial instruments of the user portfolio, and may be displayed automatically or upon user selection, in various embodiments. The “did you know” section 174 may provide positive and/or negative examples of assets or impacts of a financial instrument of a user, in various examples. In some embodiments, one or more selectable boxes 178 may be provided to provide the user with an option to alter the display by clicking on or otherwise selecting the boxes 178. In one embodiment, the selectable box 178 may provide the user with the option to select additional performance metrics for a financial instrument. Other formats for the alternative investment dashboard 170 may be used without departing from the scope of the present subject matter.

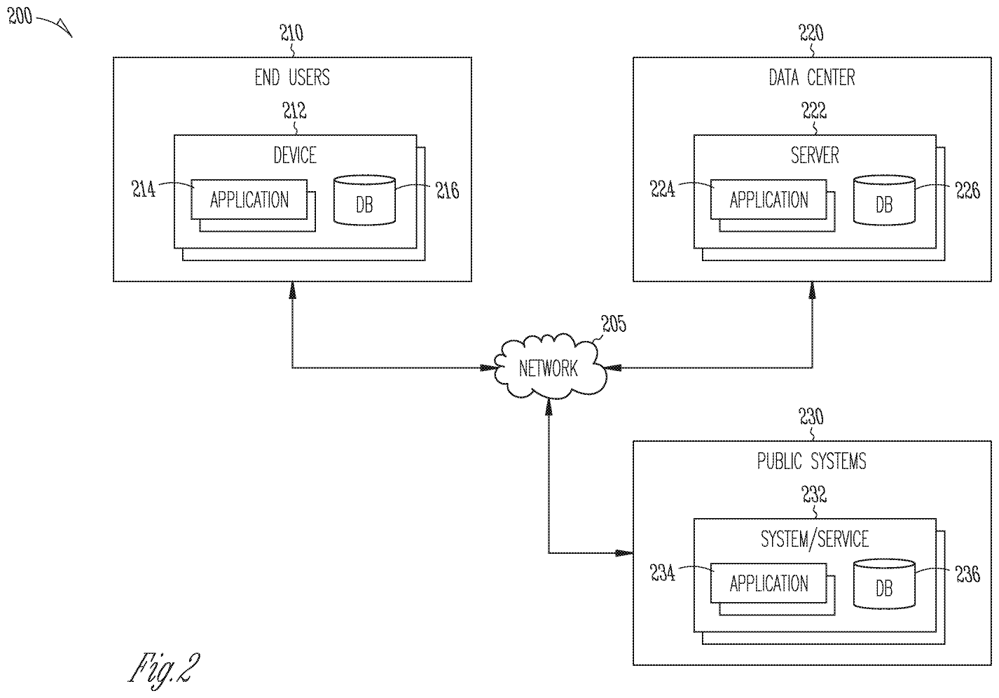

FIG. 2 illustrates an exemplary infrastructure for providing a system of the present subject matter. The infrastructure may comprise a distributed system 200 including a computing system that may include a client-server architecture or cloud computing system. Distributed system 200 may have one or more end users 210. An end user 210 may have various computing devices 212, which may be a machine 500 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The server 222 or other portions of the distributed system may create and manage the system for an alternative investment asset dashboard, such as by performing operations including the methods of FIGS. 1A-1B, in various embodiments. The business entity may be a computer service provider, as may be the case for a cloud services provider, or it may be a consumer product or service provider, such as a financial institution. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 500.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 500.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

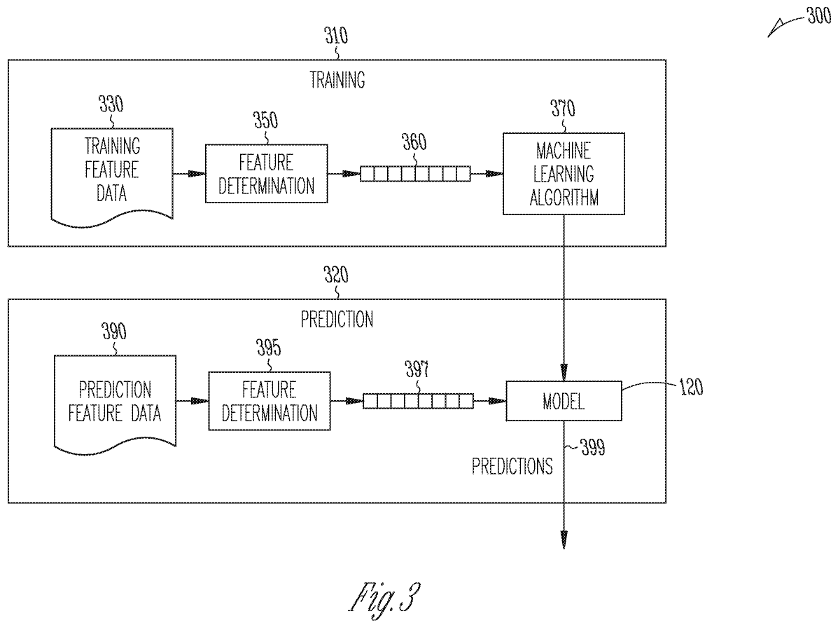

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine. In various examples, the machine learning module 300 may be used to determine physical assets or impacts of financial instruments based on the physical asset data or the impact data. In various examples, the machine learning module 300 may be used to compose an investment asset dashboard for the user based on the physical assets or the impacts.

Machine learning module 300 utilizes a training module 310 and a prediction module 320. Training module 310 inputs training feature data 330 into feature determination module 350. The training feature data 330 may include data determined to be predictive of a user-specific alternative investment asset dashboard. Categories of training feature data may include financial data, user portfolio data, tracked user data, input user data, news articles, social media data, other third-party data, or the like. Specific training feature data and prediction feature data 390 may include, for example one or more of: current tracked user data, past tracked user data, and the like.

Feature determination module 350 selects training vector 360 from the training feature data 330. The selected data may fill training vector 360 and comprises a set of the training feature data that is determined to be predictive of a user-specific alternative investment asset dashboard. In some examples, the tasks performed by the feature determination module 350 may be performed by the machine learning algorithm 370 as part of the learning process. Feature determination module 350 may remove one or more features that are not predictive of the user-specific alternative investment asset dashboard to train the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as sustainability of funds in a user investment portfolio. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method. In various embodiments, smart contracts or blockchain may be used to calculate and/or implement the alternative investment asset dashboard.

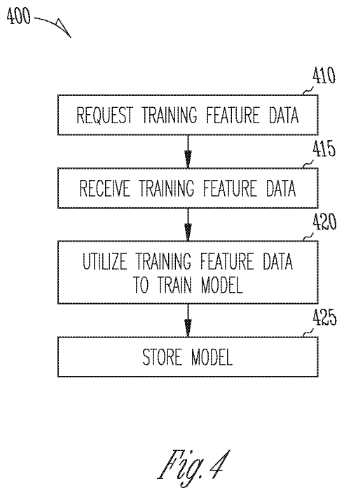

FIG. 4 illustrates a flowchart of a method 400 of training a model for providing an alternative investment asset dashboard, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions. In various examples, the model may be used to determine physical assets or impacts of financial instruments based on the physical asset data or the impact data. In various examples, the model may be used to compose an investment asset dashboard for the user based on the physical assets or the impacts.

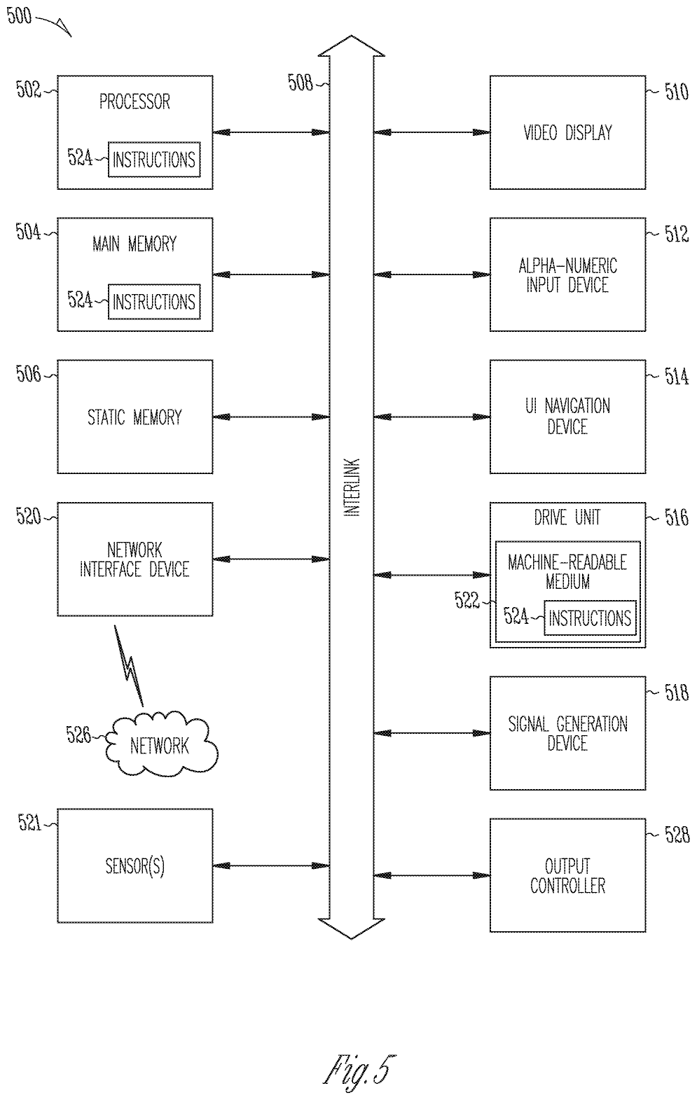

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may implement one or more of the training and prediction modules 310, 320 (e.g., as software or dedicated hardware) and may be configured to perform the methods of FIGS. 1A, 1B and 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a computer-implemented method including receiving, by a computer system, a financial asset input indicating financial instruments from or regarding a user having an online financial services account, using, by the computer system, the financial asset input to locate and extract physical asset data or impact data based on the financial asset input, determining, by the computer system, physical assets or impacts of financial instruments based on the physical asset data or the impact data, composing, by the computer system, an investment asset dashboard for the user based on the physical assets or the impacts, and displaying, on a graphical user interface in communication with the computer system, the investment asset dashboard.

In Example 2, the subject matter of Example 1 optionally further includes monitoring, by the computer system, the online financial services account of the user to detect user access, and upon detecting user access to the online financial services account, displaying the investment asset dashboard on the graphical user interface.

In Example 3, the subject matter of Example 1 optionally includes wherein one or more of using the financial asset input to locate and extract physical asset data or impact data based on the financial asset input or determining physical assets or impacts of financial instruments based on the physical asset data or the impact data includes using machine learning.

In Example 4, the subject matter of Example 1 optionally includes wherein displaying the investment asset dashboard includes displaying one or more photographic displays representing the determined physical assets.

In Example 5, the subject matter of Example 1 optionally further includes computing an index score based on the determined impacts.

In Example 6, the subject matter of Example 5 optionally includes wherein displaying the investment asset dashboard includes displaying the index score.

In Example 7, the subject matter of Example 1 optionally further includes providing, by the computer system, a notification to the user to alert the user to changes in the investment asset dashboard.

In Example 8, the subject matter of Example 7 optionally includes wherein the notification includes a push notification.

In Example 9, the subject matter of Example 7 optionally includes wherein the notification includes an email notification.

Example 10 is a system including: a computing system comprising one or more processors and a data storage system in communication with the one or more processors, wherein the data storage system comprises instructions thereon that, when executed by the one or more processors, causes the one or more processors to: receive a financial asset input indicating financial instruments from or regarding a user having an online financial services account, use the financial asset input to locate and extract physical asset data or impact data based on the financial asset input, determine physical assets or impacts of financial instruments based on the physical asset data or the impact data, compose an investment asset dashboard for the user based on the physical assets or the impacts, and display, on a graphical user interface, the investment asset dashboard.

In Example 11, the subject matter of Example 10 optionally includes wherein the data storage system comprises instructions thereon that, when executed by the one or more processors, causes the one or more processors to: monitor the online financial services account of the user to detect user access, and upon detecting user access to the online financial services account, display the investment asset dashboard on the graphical user interface.

In Example 12, the subject matter of Example 10 optionally includes wherein one or more of using the financial asset input to locate and extract physical asset data or impact data based on the financial asset input or determining physical assets or impacts of financial instruments based on the physical asset data or the impact data includes using machine learning.

In Example 13, the subject matter of Example 12 optionally includes wherein using machine learning includes using a machine learning model including one or more of a neural network, a long short-term memory (LSTM) network, bidirectional encoder representations from transformers (BERT), natural language processing (NLP), or an artificial intelligence (AI)-based knowledge tree.

In Example 14, the subject matter of Example 10 optionally includes wherein displaying the investment asset dashboard includes suggesting alternative investment options to offset assets or impacts.

In Example 15, the subject matter of Example 10 optionally includes wherein displaying the investment asset dashboard includes displaying one or more text segments identifying assets or impacts.

Example 16 is a non-transitory computer-readable storage medium, the non-transitory computer-readable storage medium including instructions that, when executed by computers, cause the computers to perform operations of: receiving a financial asset input indicating financial instruments from or regarding a user having an online financial services account, using the financial asset input to locate and extract physical asset data or impact data based on the financial asset input, determining physical assets or impacts of financial instruments based on the physical asset data or the impact data, composing an investment asset dashboard for the user based on the physical assets or the impacts, and displaying, on a graphical user interface, the investment asset dashboard.

In Example 17, the subject matter of Example 16 optionally includes wherein the medium further includes instructions that, when executed by computers, cause the computers to perform operations of: monitoring the online financial services account of the user to detect user access, and upon detecting user access to the online financial services account, displaying the investment asset dashboard on the graphical user interface.

In Example 18, the subject matter of Example 16 optionally includes wherein one or more of using the financial asset input to locate and extract physical asset data or impact data based on the financial asset input or determining physical assets or impacts of financial instruments based on the physical asset data or the impact data includes using machine learning.

In Example 19, the subject matter of Example 18 optionally includes wherein using machine learning includes using a machine learning model including one or more of a long short-term memory (LSTM) network, bidirectional encoder representations from transformers (BERT), natural language processing (NLP), or an artificial intelligence (AI)-based knowledge tree.

In Example 20, the subject matter of Example 16 optionally includes wherein displaying the investment asset dashboard includes displaying a family view to provide assets and impacts of financial instruments owned by family members of the user.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72 (b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A computer-implemented method comprising:
receiving, by a computer system, a financial asset input indicating financial instruments from or regarding a user having an online financial services account;
using, by the computer system, the financial asset input to locate and extract physical asset data or impact data based on the financial asset input;
determining, by the computer system, physical assets or impacts of financial instruments based on the physical asset data or the impact data;
composing, by the computer system, an investment asset dashboard for the user based on the physical assets or the impacts; and
displaying, on a graphical user interface in communication with the computer system, the investment asset dashboard.

2. The computer-implemented method of claim 1, further comprising:
monitoring, by the computer system, the online financial services account of the user to detect user access; and
upon detecting user access to the online financial services account, displaying the investment asset dashboard on the graphical user interface.

3. The computer-implemented method of claim 1, wherein one or more of using the financial asset input to locate and extract physical asset data or impact data based on the financial asset input or determining physical assets or impacts of financial instruments based on the physical asset data or the impact data includes using machine learning.

4. The computer-implemented method of claim 1, wherein displaying the investment asset dashboard includes displaying one or more photographic displays representing the determined physical assets.

5. The computer-implemented method of claim 1, further comprising:
computing an index score based on the determined impacts.

6. The computer-implemented method of claim 5, wherein displaying the investment asset dashboard includes displaying the index score.

7. The computer-implemented method of claim 1, further comprising:
providing, by the computer system, a notification to the user to alert the user to changes in the investment asset dashboard.

8. The computer-implemented method of claim 7, wherein the notification includes a push notification.

9. The computer-implemented method of claim 7, wherein the notification includes an email notification.

10. A system comprising:
a computing system comprising one or more processors and a data storage system in communication with the one or more processors, wherein the data storage system comprises instructions thereon that, when executed by the one or more processors, causes the one or more processors to:
receive a financial asset input indicating financial instruments from or regarding a user having an online financial services account;
use the financial asset input to locate and extract physical asset data or impact data based on the financial asset input;
determine physical assets or impacts of financial instruments based on the physical asset data or the impact data;
compose an investment asset dashboard for the user based on the physical assets or the impacts; and
display, on a graphical user interface, the investment asset dashboard.

11. The system of claim 10, wherein the data storage system comprises instructions thereon that, when executed by the one or more processors, causes the one or more processors to:
monitor the online financial services account of the user to detect user access; and
upon detecting user access to the online financial services account, display the investment asset dashboard on the graphical user interface.

12. The system of claim 10, wherein one or more of using the financial asset input to locate and extract physical asset data or impact data based on the financial asset input or determining physical assets or impacts of financial instruments based on the physical asset data or the impact data includes using machine learning.

13. The system of claim 12, wherein using machine learning includes using a machine learning model including one or more of a neural network, a long short-term memory (LSTM) network, bidirectional encoder representations from transformers (BERT), natural language processing (NLP), or an artificial intelligence (AI)-based knowledge tree.

14. The system of claim 10, wherein displaying the investment asset dashboard includes suggesting alternative investment options to offset assets or impacts.

15. The system of claim 10, wherein displaying the investment asset dashboard includes displaying one or more text segments identifying assets or impacts.

16. A non-transitory computer-readable storage medium, the non-transitory computer-readable storage medium including instructions that, when executed by computers, cause the computers to perform operations of:
receiving a financial asset input indicating financial instruments from or regarding a user having an online financial services account;
using the financial asset input to locate and extract physical asset data or impact data based on the financial asset input;
determining physical assets or impacts of financial instruments based on the physical asset data or the impact data;
composing an investment asset dashboard for the user based on the physical assets or the impacts; and
displaying, on a graphical user interface, the investment asset dashboard.

17. The non-transitory computer-readable storage medium of claim 16, wherein the medium further includes instructions that, when executed by computers, cause the computers to perform operations of:
monitoring the online financial services account of the user to detect user access; and
upon detecting user access to the online financial services account, displaying the investment asset dashboard on the graphical user interface.

18. The non-transitory computer-readable storage medium of claim 16, wherein one or more of using the financial asset input to locate and extract physical asset data or impact data based on the financial asset input or determining physical assets or impacts of financial instruments based on the physical asset data or the impact data includes using machine learning.

19. The non-transitory computer-readable storage medium of claim 18, wherein using machine learning includes using a machine learning model including one or more of a long short-term memory (LSTM) network, bidirectional encoder representations from transformers (BERT), natural language processing (NLP), or an artificial intelligence (AI)-based knowledge tree.

20. The non-transitory computer-readable storage medium of claim 16, wherein displaying the investment asset dashboard includes displaying a family view to provide assets and impacts of financial instruments owned by family members of the user.
